(19) United States
(12) Patent Application Publication
(10) Pub. No.: US 2008/0127734 A1
(43) Pub. Date: Jun. 5, 2008

(54) VIBRATION MEASUREMENT SYSTEM AND GAS TURBINE ENGINE INCLUDING THE SAME

(76) Inventors: Gert Johannes van der Merwe, Monroe, OH (US); Daniel Edward Mollmann, Cincinnati, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 11/565,120

(22) Filed: Nov. 30, 2006

(51) Int. Cl. G01M 1/22

(52) U.S. Cl. 73/660

(57) ABSTRACT

A vibration measurement system for a gas turbine engine. The vibration measurement system includes a first accelerometer coupled to the gas turbine engine, the first accelerometer configured to transmit a first identifier, a second accelerometer coupled to the gas turbine engine, the second accelerometer configured to transmit a second identifier that is different than the first identifier, and a signal conditioning computer coupled to the first and second accelerometers for receiving the first and second identifiers, the signal conditioning computer configured to determine which of the first and second accelerometers is connected to the signal conditioning computer based on the first and second identifiers.

### BACKGROUND OF THE INVENTION

This invention relates generally to vibration measurement systems for a gas turbine engine, and more particularly, to a vibration measuring system that is configured to determine whether an accelerometer is functioning as a primary accelerometer or a backup accelerometer.

In at least some known aircraft engines, two accelerometers and an associated signal conditioning system are used to provide an indication of engine vibration to a flight crew. In at least some engines, one accelerometer is internally mounted and one is externally mounted. Specifically, in such embodiments, generally the internally mounted accelerometer is mounted adjacent to a component that is sensitive to vibrations generated within the gas turbine engine, such as a fan bearing, and the externally mounted accelerometer is generally mounted to a structural component that is not as sensitive to engine vibration, such as a fan frame.

Generally, in such embodiments, if the internally mounted accelerometer fails, a third accelerometer is installed externally, and used in place of the internally mounted accelerometer. Although engine balance coefficients are typically different between the internally mounted accelerometer and the new externally mounted accelerometer, the difference is generally accommodated by software that is installed in the signal conditioning computer at the time the accelerometers are installed.

During operation, the accelerometer in use is physically connected to the signal conditioning computer. In order to switch between the internally mounted accelerometer and the externally mounted accelerometer, or vice-versa, one of the accelerometers must be disconnected from the computer prior to the other accelerometer being connected. The signal conditioning computer must also be reconfigured to the correct accelerometer setting, based upon which accelerometer is in use. If the computer is improperly configured, the wrong accelerometer coefficients will be used, and balancing the engine for correct vibration measurement would be extremely difficult. As a result, it is essential to properly configure the signal conditioning computer in the event a failure of the primary accelerometer occurs.

### BRIEF DESCRIPTION OF THE INVENTION

In one aspect, a vibration measurement system for a gas turbine engine is provided. The vibration measurement system includes a first accelerometer coupled to the gas turbine engine assembly, the first accelerometer configured to transmit a first identifier, a second accelerometer coupled to the gas turbine engine assembly, the second accelerometer configured to transmit a second identifier that is different than the first identifier, and a signal conditioning computer coupled to the first and second accelerometers for receiving the first and second identifiers, the signal conditioning computer configured to determine which of the first and second accelerometers is connected to the signal conditioning computer based on the first and second identifiers.

In another aspect, an accelerometer is provided. The accelerometer includes a positive connection that is coupled to an amplifier, a negative connection that is coupled to the amplifier, a ground connection coupled to a ground, and an identifier connection configured to transmit an identifier to a computer, the computer configured to determine which of the first and second accelerometers is connected to the signal conditioning computer based on the identifier.

In a further aspect, a gas turbine engine assembly is provided. The gas turbine engine assembly includes a gas turbine engine and a vibration measurement system coupled to the gas turbine engine. The vibration measurement system includes a first accelerometer coupled to the gas turbine engine, the first accelerometer configured to transmit a first identifier, a second accelerometer coupled to the gas turbine engine, the second accelerometer configured to transmit a second identifier that is different than the first identifier, and a signal conditioning computer coupled to the first and second accelerometers for receiving the first and second identifiers, the signal conditioning computer configured to determine which of the first and second accelerometers is connected to the signal conditioning computer based on the first and second identifiers.

### BRIEF DESCRIPTION OF THE DRAWINGS

FIG. 1 is a block diagram illustration showing an internally mounted accelerometer and an externally mounted accelerometer each connected to a signal conditioning computer;

FIG. 2 is a block diagram illustration showing a backup accelerometer connected to the signal conditioning computer;

FIG. 3 is an illustration of an accelerometer comprising a first identifying connection internally coupled to ground; and

FIG. 4 is an illustration of an accelerometer comprising a second identifying connection internally coupled to a resistive element.

### DETAILED DESCRIPTION OF THE INVENTION

FIG. 1 is a simplified block diagram of a gas turbine engine assembly 6 that includes an exemplary vibration measurement system 8. Vibration measurement system 8 includes a first accelerometer 12, that in the exemplary embodiment is mounted internally within gas turbine engine assembly 6. For example, first accelerometer 12 is typically mounted at the most sensitive location to detect a fan imbalance, such as the forward most bearing, which is nearest a fan rotor. Vibration measurement system 8 also includes a second accelerometer 13, that in the exemplary embodiment is mounted to an external location on gas turbine engine assembly 6. During assembly, accelerometer 13 is typically mounted on a casing or frame. For example, accelerometer 13 may be mounted on a turbine center frame, a turbine rear frame, a low-pressure turbine casing, a turbine exhaust case, or a high-pressure compressor case.

During operation, the internal accelerometer 12 and external accelerometer 13 are each connected via a wiring harness 14 and 15 to a signal conditioning computer 18, typically located in the electronics bay of the aircraft, or mounted on the gas turbine engine. The accelerometer signals are typically processed by electronic signal conditioning hardware that is installed in the signal conditioning computer 18 and that performs functions such as determining the synchronous vibration levels, calculating balance weights needed to balance the engine, scaling vibration amplitudes for cockpit display, storing data for later retrieval, generating maintenance messages, and other functions. A Maintenance Access Terminal (MAT) 20 is associated with the signal conditioning computer, to allow a technician or other person to access the data and interface in other ways with the signal conditioning computer 18.

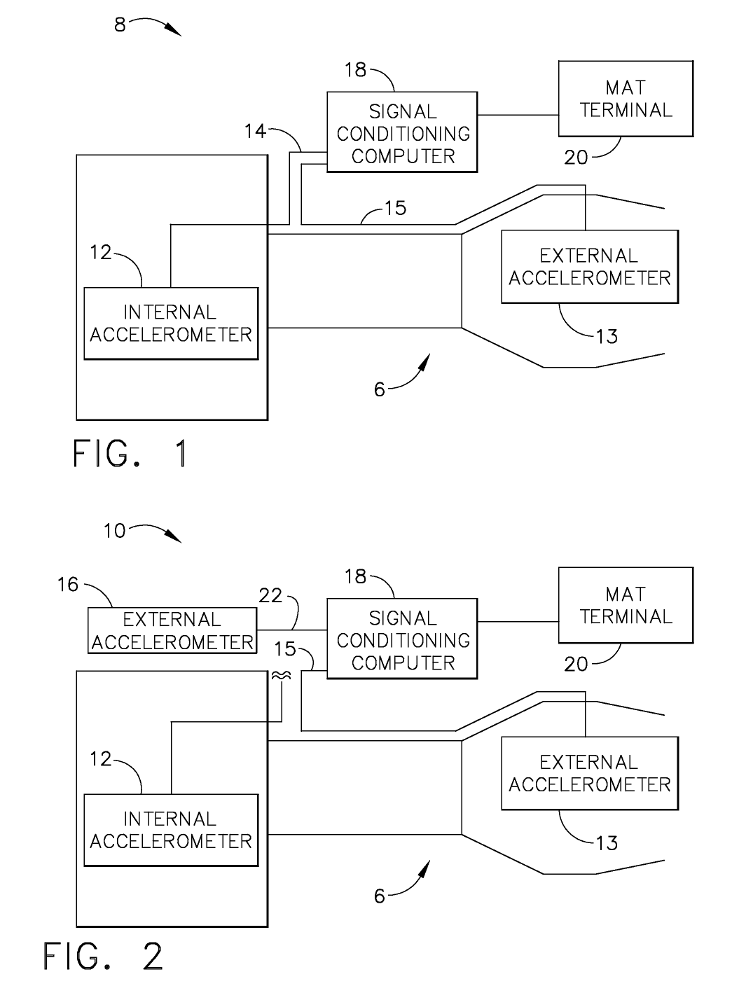

FIG. 2 is a simplified block diagram of an exemplary vibration measurement system 10 that may be used with gas turbine engine assembly 6. In the exemplary embodiment, vibration measurement system 10 is utilized as a backup system for vibration measurement system 8 shown in FIG. 1. More specifically, in the event that accelerometer 12 experiences a failure, internal accelerometer 12 may be disconnected from the signal conditioning computer 18, and a backup accelerometer 16 may be coupled to signal conditioning computer 18 to function as a replacement for accelerometer 12. In the exemplary embodiment, accelerometer 16 is mounted externally on gas turbine engine 6 and connected, via a backup wiring harness 22, to the signal conditioning computer 18. The preferred embodiment includes wiring 14 and backup wiring harness 22 as two distinct components, however, those skilled in the art will recognize that wiring harness 14 and wiring harness 22 may be the same component or may be connected to both accelerometers 12 and 16 simultaneously by use of a switch.

The backup vibration measurement system 10 is used as a backup accelerometer system to the primary vibration measurement system 8. Specifically, external accelerometer 16 is used as a backup accelerometer in the event of some failure or error of internal accelerometer 12. The sensor location for the external accelerometer 16 typically is not as sensitive as the internal location, but has an acceptable sensitivity to fan imbalance for use in the event the internal accelerometer 12 fails.

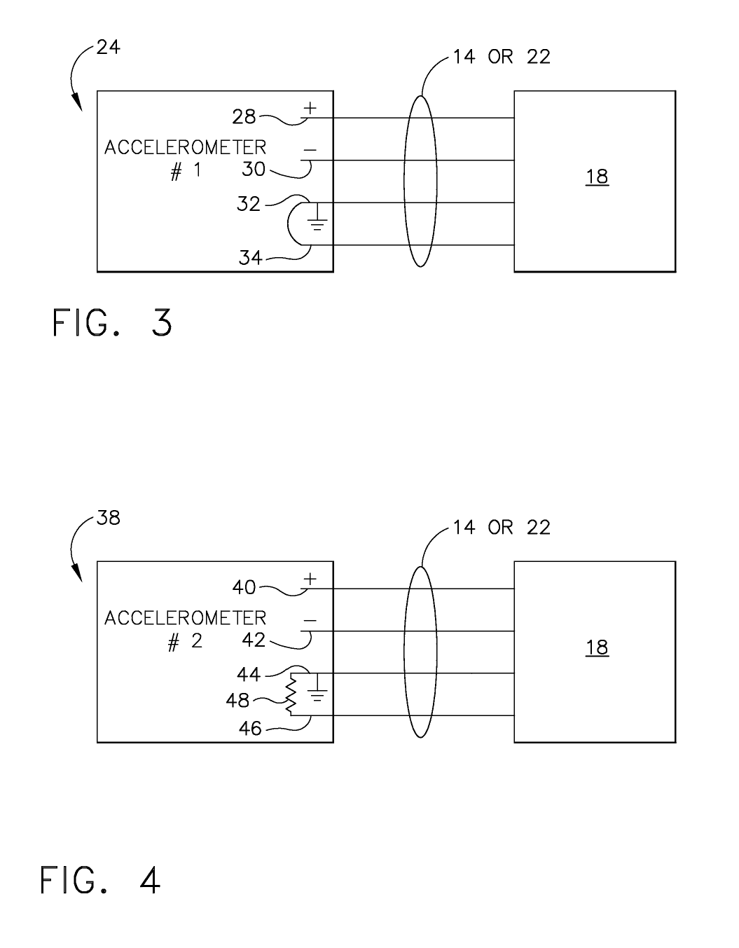

FIG. 3 is a simplified block diagram of an exemplary accelerometer 24 that may be used to replace either accelerometer 12 or 16 shown in FIG. 2. That is, accelerometer 24 may be mounted either internally or externally on gas turbine engine assembly 6. As such, accelerometer 24 includes four connecting points or wires that are utilized to connect accelerometer 24 to the signal conditioning computer 18 shown in FIG. 2. Specifically, accelerometer 24 includes a positive connection 28, a negative connection 30, and a ground connection 32.

More specifically, the positive and negative connections 28 and 30 are coupled to the respective positive and negative terminals of an amplifier, such as signal conditioning computer 18, to amplify the output of accelerometer 24. Moreover, ground connection 32 is coupled to a grounding terminal on signal conditioning computer 18 or other suitable ground.

Accelerometer configuration 24 also includes a first identifying connection 34. In the preferred embodiment, the first identifying connection 34 is internally connected to the grounding connection 32, and externally connected to the signal conditioning computer 18 via wiring harness 14. However, those skilled in the art will recognize that the first identifying connection 34 may be connected to a variety of grounding locations. Specifically, during operation, signal conditioning computer 18 receives a first indication signal from accelerometer 24 that indicates accelerometer 24 is grounded.

FIG. 4 is a simplified block diagram of an exemplary accelerometer 38 that may be used to replace either accelerometer 12 or 16 shown in FIGS. 1 and 2. That is, accelerometer 38 may be mounted either internally or externally on gas turbine engine assembly 6. As such, accelerometer 38 includes four connecting points or wires that are utilized to connect accelerometer 38 to the signal conditioning computer 18 shown in FIG. 2. Specifically, accelerometer 38 includes a positive connection 40, a negative connection 42, and a ground connection 44.

More specifically, the positive and negative connections 40 and 42 are coupled to the respective positive and negative terminals of an amplifier, such as signal conditioning computer 18, to provide power to accelerometer 38. Moreover, ground connection 44 is coupled to a grounding terminal on signal conditioning computer 18 or other suitable ground.

Accelerometer configuration 38 also includes an identifying connection 46. In the preferred embodiment, identifying connection 46 is different than identifying connection 34. More specifically, each of accelerometers 24 and 38 is configured to transmit a different signal to the signal conditioning unit 18 such that signal conditioning unit 18 can distinguish between accelerometers 24 and 38. In the exemplary embodiment, second identifying connection 46 is internally connected to a resistor 48 having a relatively high resistance. For example, as shown in FIG. 4, resistor 48 is coupled between the ground connection 44 and the second identifying connection such that during operation, signal conditioning computer 18 receives a second indication signal from accelerometer 38 that indicates that the second identifying connector is floating, i.e. the signal condition computer 18 measures high resistance between ground and the second identifying connection 46.

Described herein are two exemplary accelerometers that may be utilized to replace the accelerometers 12 or 16 shown in FIGS. 1 and 2. Specifically, accelerometers 24 and 38 may be mounted either internally or externally to gas turbine engine assembly 6. Specifically, during installation, accelerometer 34 may be installed in the gas turbine engine to function as either the internal accelerometer 12 or the external backup accelerometer 16, with the remaining of the internal accelerometer 12 or the external accelerometer 16 being configured as the second accelerometer configuration 38. The first identifying connection 34 and the second identifying connection 46 are connected to the signal conditioning computer 18, by either wiring harness 14 or backup wiring harness 22, depending on which accelerometer 12 or 16 has which configuration 24 or 38. By including either the first identifying connection 34 or the second identifying connection 46, the signal conditioning computer 18 can assign a discrete value, identifying which accelerometer 12 or 16 is connected to the signal conditioning computer 18, based on whether the accelerometer 12 or 16 is grounded (accelerometer configuration 24) or floating high resistance (accelerometer configuration 38). By identifying which accelerometer 12 or 16 is connected, the present invention eliminates the need of a technician to configure the signal conditioning computer 18 as to which accelerometer 12 or 16 is in use.

A system and method are proposed for eliminating the need for a technician to configure the signal conditioning computer as to which accelerometer is in use. The improved accelerometer configuration uses accelerometers that include connections coupled to differing wiring configurations, such that the computer can automatically identify which accelerometer is in use. Specifically, each accelerometer is configured to transmit an identifier that is unique to that specific accelerometer such that the signal condition computer 18 can determine which accelerometer is connected to the signal conditioning computer 18.

While this invention has been described with reference to a preferred embodiment, it will understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A vibration measurement system for a gas turbine engine, said vibration measurement system comprising:
a first accelerometer coupled to said gas turbine engine, said first accelerometer configured to transmit a first identifier;
a second accelerometer coupled to said gas turbine engine, said second accelerometer configured to transmit a second identifier that is different than said first identifier; and
a signal conditioning computer coupled to said first and second accelerometers for receiving the first and second identifiers, said signal conditioning computer configured to determine which of said first and second accelerometers is connected to said signal conditioning computer.

2. A vibration measurement system in accordance with claim 1, wherein first and second accelerometers each comprise a positive connection, a negative connection, a ground connection and an identifier connection.

3. A vibration measurement system in accordance with claim 2, wherein said first accelerometer ground connection is coupled directly to said first accelerometer identifier connection.

4. A vibration measurement system in accordance with claim 2, wherein said second accelerometer comprises a resistor that is coupled between said second accelerometer ground connection and said second accelerometer identifier connection.

5. A vibration measurement system in accordance with claim 2, wherein at least one of said first and second accelerometers is mounted internally within the gas turbine engine, said remaining accelerometer is mounted to an external surface of said gas turbine engine.

6. A vibration measurement system in accordance with claim 1, wherein said signal conditioning computer comprises software for assigning a discrete value to said first and second accelerometers based on said first identifier and second identifiers.

7. A vibration measurement system in accordance with claim 1, wherein said second external accelerometer is configured to detect vibrations caused by imbalances in the gas turbine engine.

8. An accelerometer comprising:
a positive connection that is coupled to an amplifier;
a negative connection that is coupled to said amplifier;
a ground connection coupled to a ground; and
an identifier connection configured to transmit an identifier to a computer, said computer configured to identify said accelerometer based on the received signal

9. An accelerometer in accordance with claim 8, wherein said accelerometer ground connection is coupled directly to said first accelerometer identifier connection.

10. An accelerometer in accordance with claim 8, further comprising a resistor that is coupled between said accelerometer ground connection and said accelerometer identifier connection.

11. A combination comprising:
a gas turbine engine; and
a vibration measurement system coupled to said gas turbine engine, said vibration measuring system comprising
a first accelerometer coupled to said gas turbine engine, said first accelerometer configured to transmit a first identifier;
a second accelerometer coupled to said gas turbine engine, said second accelerometer configured to transmit a second identifier that is different than said first identifier; and
a signal conditioning computer coupled to said first and second accelerometers for receiving the first and second identifiers, said signal conditioning computer configured to determine which of said first and second accelerometers is connected to said signal conditioning based on said first and second identifiers.

12. A combination in accordance with claim 11, wherein each of said first and second accelerometers comprise a positive connection, a negative connection, a ground connection, and an identifier connection.

13. A combination in accordance with claim 11, wherein said first accelerometer ground connection is coupled directly to said first accelerometer identifier connection.

14. A combination in accordance with claim 11, wherein said second accelerometer comprises a resistor that is coupled between said second accelerometer ground connection and said second accelerometer identifier connection.

15. A combination in accordance with claim 11 wherein at least one of said first and second accelerometers is mounted internally within the gas turbine engine, said remaining accelerometer is mounted to an external surface of said gas turbine engine.

16. A combination in accordance with claim 11, wherein said signal conditioning computer comprises software for assigning a discrete value to said first and second accelerometers based on said first identifier and second identifiers.

17. A combination in accordance with claim 11, wherein said second external accelerometer is configured to detect vibrations caused by imbalances in the gas turbine engine.
